(19) United States
(12) Patent Application Publication
(10) Pub. No.: US 2008/0313944 A1
(43) Pub. Date: Dec. 25, 2008

(54) MULTI-GRIP PROMOTIONAL APPLIQUE

(76) Inventor: ROBERT SCOTT LEAR, Chatsworth, CA (US)

Correspondence Address: CHANCELLOR IP, 3463 RED BLUFF CT., SEMI VALLEY, CA, 93063, US

(21) Appl. No.: 12/143,012

(22) Filed: Jun. 20, 2008

Related U.S. Application Data
(60) Provisional application No. 60/936,723, filed on Jun. 22, 2007.

(51) Int. Cl. G09F 3/18

(52) U.S. Cl. 40/661.11

(57) ABSTRACT

A stabilizing appliqué including means for presenting viewable expressive media.

### PRIORITY CLAIM

This utility patent application claims the benefit of U.S. Prov. Pat. Appl. No. 60/936,723 filed Jun. 22, 2007 by inventor Robert Scott Lear.

### BACKGROUND OF THE INVENTION

1. Field of the Invention

The present invention relates to an appliqué for resisting relative m motion between objects it separates and for displaying promotional material.

2. Discussion of the Related Art

A problem in using the human body to support objects such as musical instruments is stability at the point(s) of contact between the object and the user. Because the contact point(s) on some such objects is finished by the manufacturer to have a slick or polished surface tending to cause undesirable instability including unintended movement or slippage of the object aggravates the problem.

### SUMMARY OF THE INVENTION

The present invention utilizes an appliqué to enhance stability of objects supported by the human body and provides a means for displaying content and/or viewable expressive media such as promotional messages. Objects which can be supported by the invention include musical instruments, computers, tools, firearms, personal electronics such as cell phones, video game controllers and similar devices, school/business supplies such as notebooks, clipboards, backpacks and similar devices, sporting goods, hand rails, medical healthcare devices such as devices for immobilizing body parts of medical patients and devices of related industries, and the like.

The appliqué or any combination of layers comprising the appliqué can be in any shape or size and die, laser, roller or water jet cut to any desired design. Among other things, the appliqué of the present invention grips an object and a user to enhance the user's control of the object. The invention also enables the display of promotional messages by, among other things, utilizing opaque or transparent layers with associated messages that are affixed by any suitable means including silk screening, digital reproduction and other suitable means known in the art.

In an embodiment, an appliqué in accordance with the present invention includes a first surface adhered by a first grip to a first object and a second surface adhered by a second grip to a second object. Here, the strength of the second grip is sufficient to resist separation of the second surface from the second object when the first surface is separated from the first object and a promotional message layer is made visible to onlookers when the first surface is separated from the first object.

In yet other embodiments of the invention, the message or a design element can be reproduced onto the outermost layer that touches the user, such as with the use of tacified or Plastisol type inks providing promotional utility while maintaining desirable non-slip characteristics.

Another object and advantage of this invention is not only through use of transparent or opaque material, screen print, digital reproduction, but also by embossing, cut through or any combination of. Promotional viability is thus obtained for customers, or those that require a design element added to the invention.

### BRIEF DESCRIPTION OF THE DRAWINGS

The present invention is described with reference to the accompanying figures. These figures, incorporated herein and forming part of the specification, illustrate the present invention and, together with the description, further serve to explain the principles of the invention and to enable a person skilled in the relevant art to make and use the invention.

FIG. 1 is an exploded view of an appliqué of the present invention.

FIG. 2 is an exploded view of a layer of the invention of FIG. 1.

FIG. 3 shows the invention of FIG. 1 as it is used in connection with guitar.

### DETAILED DESCRIPTION OF THE PREFERRED EMBODIMENTS

The disclosure provided in the following pages describes examples of some embodiments of the invention. The designs, figures, and description are non-limiting examples of certain embodiments of the invention. For example, other embodiments of the disclosed device may or may not include the features described herein. Moreover, disclosed advantages and benefits may apply to only certain embodiments of the invention and should be not used to limit the disclosed inventions.

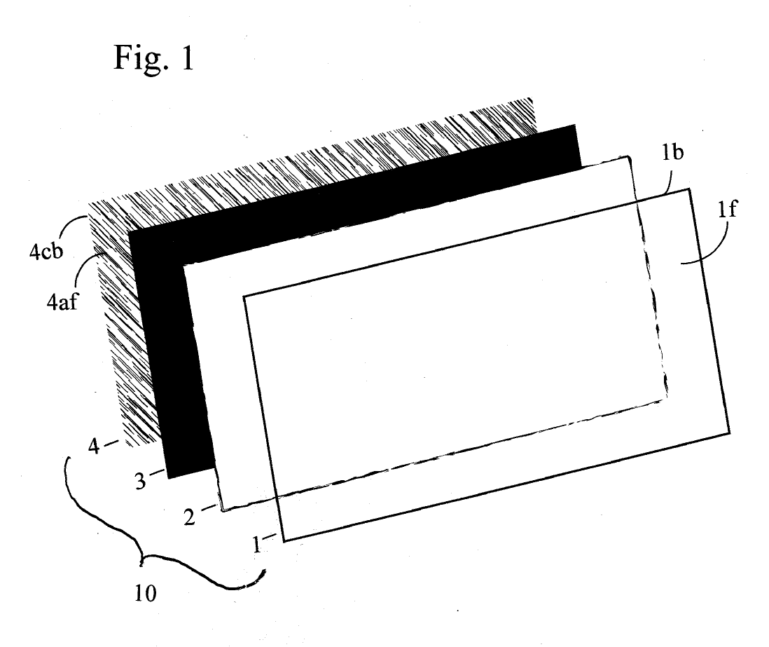

FIG. 1 shows an exploded view of an appliqué device in accordance with the present invention. Included in the appliqué are a plurality of layers including at least a first grip layer 1, a message layer 2 and a second grip layer 4. In some embodiments, a cushioning layer 3 is included and located between the first and second grip layers.

The first grip layer 1 is a flexible polymer or natural material presenting a tacky or sticky surface 1f . This layer is transparent or translucent. Materials of construction include one or more of clear rubber, poly vinyl chlorides (PVC), tacified PVC, silicone materials including silicone rubbers and other suitably flexible materials. The properties of such materials may include a tacky or sticky surface characteristic; some materials selected may be suitable for use with a coating having this desired characteristic. Coatings include any suitable adhesives and tacky or sticky coatings such as silicone coatings and other coatings known by persons of ordinary skill in the art to be suitable in such applications. In various embodiments, the first grip layer has thicknesses in inches in the ranges of 0.01 to 0.25 and more preferred thicknesses in the range of 0.05 to 0.10.

For presenting a message, the message layer 2 lies in the plane indicated by the rectangular boundary line. While the message layer is bounded by the boundary line, the message layer need not be coextensive with the entire area within the boundary line. For example, to the extent the message is a word, then the message layer need only include the material required to form the message, here the letters making up the word; it is obvious that in some embodiments the “negative” of the word shape could also be formed. In other embodiments, the message layer may be coextensive with the entire area within the boundary line.

The message layer includes one or more of the expressive materials used in the printing, messaging, and other communications arts including the fine arts known by persons of ordinary skill in the art to be suitable for this application. Selected message layer materials include ink or another contrasting material that is visibly distinguishable from its background and/or surroundings. Such other materials include one or more of flowable pigmented materials, solids forming symbols, shapes and designs, and materials able to be etched. Methods of application include, for example, silk screening.

An optional cushioning layer 3 reduces user discomfort and the potential for object damage associated with forces exchanged between a user and the object 6. Where used, the cushioning layer is typically located between the first and second grip layers and is made of a foam material known in the art such as a foam made from ethylene, ethylene vinyl acetate, polyolefin elastomer, metallocene polyolefin elastomer, nitrile, polyethlyne, polyurethane, foamed rubbers, viscoelastic foams and other suitable materials.

The second grip layer 4 includes a surface 4af interfacing with another layer 2, 3 and a surface 4cb for gripping an object such as a musical instrument 6 (See FIG. 6). In some embodiments, an adhesive layer, such as a sprayed on adhesive or another applied adhesive adheres to another layer 2, 3 and forms the second grip layer.

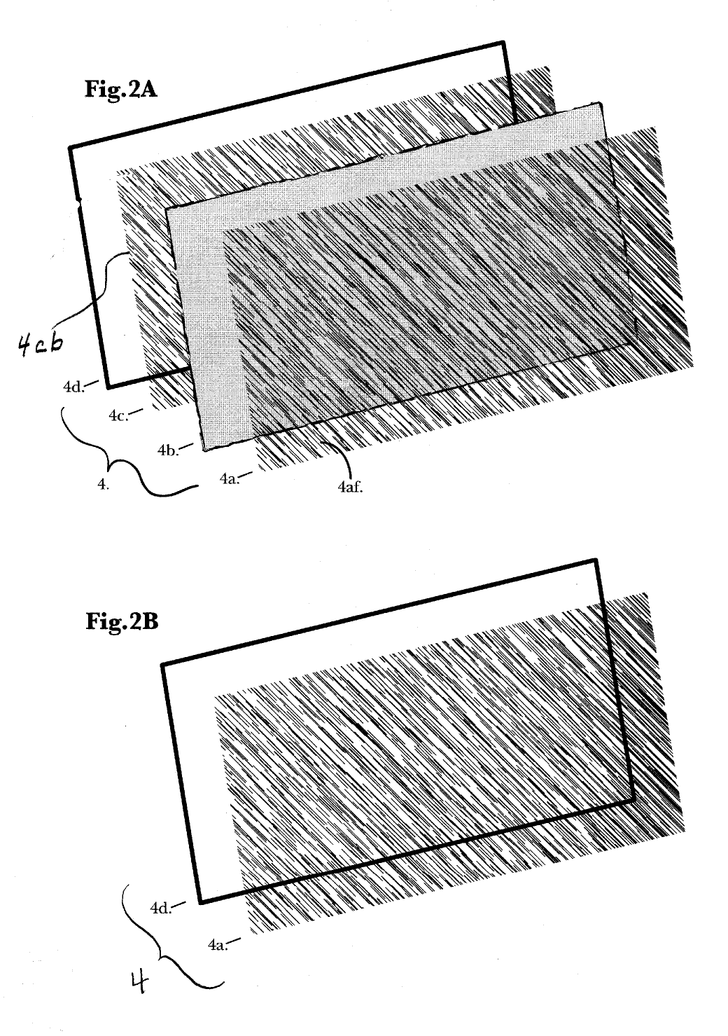

In embodiments illustrated by FIG. 2A, the second grip layer 4 may be formed of multiple layers. For example, in an embodiment having layers 4a-d, an adhesive layer 4a attaches a thin substrate 4b, such as a mylar, acrylic or another polymeric film, to another layer 2, 3. Here, another adhesive layer 4c is for attaching the substrate to an object 6. A protective covering such as a waxed paper 4d protects an otherwise exposed surface of the adhesive 4cb. In some embodiments, the second grip layer includes a transfer adhesive such as a transfer adhesive made by 3M Corporation having two adhesive layers separated by a thin substrate.

In embodiments illustrated by FIG. 2B, the second grip layer 4 may be formed of multiple layers. For example, in an embodiment having layers 4a and 4d, an adhesive layer 4a is applied, for example by spraying or another suitable application technique, to another layer 2, 3. A protective covering such as waxed paper 4d protects an otherwise exposed surface of the adhesive 4cb.

In various embodiments, the second grip layer 4 utilizes an suitable type of adhesive in connection with an appropriate method of application to maintain the fixation between the object 6 and the appliqué 10 while the user and the appliqué are being separated. Such types of adhesives and methods of application will be well known to persons of ordinary skill in the adhesive arts and include one or more of 3M Stock Nos. F9465PC, 9471 and 300 LSE.

In some embodiments, the adhesion between the exposed surface of the second grip layer 4cb and an object 6 results from a static electric charge. Here, the inclusion of a material able to be charged with static electricity, such as natural, synthetic, polymeric and elastomeric materials including without limitation synthetic rubbers and other materials known by those of ordinary skill in the art to be suited to this application, in a layer 1, 2, 3 of the appliqué 10 provides an adhesion, when charged, due to the attraction of materials bearing dissimilar electric charges.

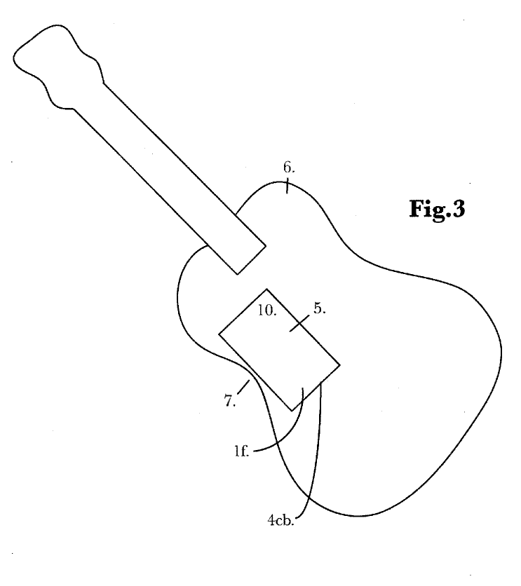

FIG. 3 is an isometric view in relation to an example object, a musical instrument in the form of a guitar. The appliqué is applied on the back of the instrument in a location that is consistent with a known point of contact between this particular instrument and the instrument user. Demonstrated here is an example of appliqué placement, on the back, lower section of the instrument for contact and enhanced stability between the user and the instrument. Here, the contact point is above a user's right knee and the appliqué comes into contact here to prevent slippage of the instrument and enhance control and playing precision available to the user.

As shown in FIG. 3, in operation the second grip layer 4 of the appliqué 10 is adhered to an object 6 in a location 7 where the object normally comes into contact with the user. While the user is normally supporting the object, the tacky or sticky surface if of the first grip layer 1 of the appliqué clings typically to either the body or the clothing of the user it contacts and tends to improve object stability by reducing relative motion between the user and the object. Where the user and the appliqué touch, the appliqué offers an enhanced coefficient of friction reducing instability of the object 7.

When the user is separated from the appliqué, exposing the free surface of the appliqué If, the message layer and its contents 2 become visible through the transparent or translucent layer(s) overlying the message layer. In addition, separation of the object and the user does not cause separation of the object and the appliqué; and, once the object and user are separated, observers may view the message of the message layer at the free surface of the exposed grip layer.

In yet other embodiments, the first grip layer 1 can be used alone if manufactured with a material that provides a static cling adhesion between the invention and the instrument. This layer offers in addition to enhanced control of the instrument, an advertising canvas that can be directly silk screened or utilize reproduced artwork to provide a medium for promotional content as dictated by the customer.

What is claimed is:

1. An appliqué comprising:
a first surface adhered by a first grip to a first object;
a second surface adhered by a second grip to a second object;
the strength of the second grip being sufficient to resist separation of the second surface from the second object when the first surface is separated from the first object; and,
a promotional message layer being made visible to onlookers when the first surface is separated from the first object.

2. The appliqué of claim 1, further comprising a first grip layer through which the promotional message layer is visible.

3. The appliqué of claim 2, further comprising a second grip layer bearing an adhesive enabling the second grip on the second object.

4. The appliqué of claim 3, wherein material of the first grip layer in close proximity to the first object is sticky and enables a selectively breakable first grip on the first object.

5. The appliqué of claim 3 further comprising statically electrically charged material that is primarily responsible for development of the second grip.

6. The appliqué of claim 4 wherein the first object is a musician and the second object is a musical instrument.

7. The appliqué of claim 4 wherein the first object is a computer user and the second object is a computer.

8. The appliqué of claim 4 wherein the first object is a medical patient and the second object is a structure immobilizing a body part of the medical patient.

9. An applique' comprising:
first, second, and third layers;
the first layer being a first gripping layer for gripping a human;
the second layer being a layer containing viewable expressive media;
the third layer being a second gripping layer for gripping an object;
the third layer including at least an adhesive layer and a protective layer for protecting a surface of the adhesive layer;
the strength of a second grip of the second gripping layer being sufficient to resist separation of a second surface from a second object when a first surface is separated from a first object; and, the viewable expressive media being made visible to onlookers when the first surface is separated from the first object.
